(19) United States
(12) Patent Application Publication
(10) Pub. No.: US 2008/0048810 A1
(43) Pub. Date: Feb. 28, 2008

(54) Actuating Device

(75) Inventors: Martin Bill, Nohfelden (DE); Christoph Meyer, Saarbrucken (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: HYDAC ELECTRONIC GMBH, Saarbruecken (DE)

(21) Appl. No.: 11/659,662

(22) PCT Filed: Oct. 7, 2005
(86) PCT No.: PCT/EP05/10794

§ 371 Date: Feb. 7, 2007

(30) Foreign Application Priority Data
Oct. 21, 2004 (DE) 10 2004 051 332.5

(51) Int. Cl. H01F 7/08

(52) U.S. Cl. 335/262

(57) ABSTRACT

The invention relates to an actuating device, particularly for actuating externally connected valves, comprising a housing (10) and a coil member (12). Said coil member (12) is disposed in the housing (10), is provided with a coil winding (14), and at least partially encompasses a pole tube (16). A pole core (20) adjoins one free end of said pole tube (16). The actuating device further comprises at least one armature (22) which is guided within an armature chamber (24) at least in the pole tube (16) and cooperates with a part for actuating the respective valve. In order to dispense with the need for an independent lift stop used in prior art, the pole tube (16) is configured like a receiving jacket for the armature (22), one free end of said receiving jacket being provided with an inward-facing folded edge so as to foam a stop area (38) for the armature (22).

The invention relates to an actuating device, in particular for actuation of valves which can be connected externally, having a housing and a coil element located therein with a coil winding, which encompasses at least in part one pole tube with a pole core connected to its one free end, with a magnet armature which is guided at least in the pole tube within the armature chamber and which interacts with the actuating part for actuating the respective valve.

These actuating devices which are to some extent also termed actuating magnets in technical jargon are described for example in DE 101 04 998 A1 and are freely available commercially in a host of versions. The actuation part of the actuating magnet is formed essentially from a tubular pin which, when the coil winding is electrically excited via a connector plug which can be connected to the plug plate of a connector, traverses a definable path and in the process actuates an actuating or switching process, for example in an externally connected valve for blocking or routing of fluid flows. If there is no power, the actuating magnet therefore being de-energized, generally the magnet armature is reset via a reset spring which is located in the switching device itself and/or preferably on the valve to be actuated, for a repeated switching process when the coil is supplied with current.

In the generic actuating device according to the contents of DE 10 2004 028 871 which was published at a later date, the free end of the cylindrical pole tube is fixed in a corresponding receiving space between the outer peripheral side of the pole core and the inner peripheral side of the coil element, in this region the pole tube being made continuously cylindrical. On its other opposite free end the pole tube is flanged to the interior and is securely connected to a plug-like stroke limit for the magnet armature, the magnet armature being able to move back and forth between the stroke limit and also a stop surface and a so-called anti-adhesion disk as the other opposite stop surface, depending on the coil voltage present, the cup-shaped anti-adhesion disk ensuring that when the magnet armature strikes in the direction of the pole core it can be easily released again for traveling motion in the other direction. In the region of the stroke limit the pole tube is sealed on the inner peripheral side relative to this stroke limit via a gasket, and otherwise the combination of the pole tube and the stroke limit on the outer peripheral side is encompassed by a screw-on cover cap of plastic material.

The indicated actuating device is designed for high application pressures and can be produced economically and in a space-saving manner due to its modular structure. Especially for low pressure applications this actuating device, however, is “overly dimensioned” and especially in the edge areas of the working stroke of the actuating device the actuating force to be applied cannot always be kept constant over the positioning travel or otherwise fixed in a defined manner; this is fundamentally desirable in terms of the areas of application for these devices.

On the basis of this prior art, the object of the invention is to further improve the known actuating devices while retaining their advantages, such that they manage with few and “lightly” dimensioned components especially for low pressure applications and that it becomes possible even with an already prepared actuating device on site to effect adaption with respect to the indicated working stroke of the device. This object is achieved by a device with the features of claim 1 in its entirety.

In that, as specified in the characterizing part of claim 1, the pole tube is made in the form of a receiving sleeve for the magnet armature which with the formation of a stop surface for the magnet armature on its one free end has a flange edge facing toward the interior, automatic stroke limitation as is shown in the prior art can be omitted and one free end of the pole tube with the flange edge which faces toward the interior in this way directly effects path limitation or stop limitation for the magnet armature. In order to be able to reliably divert these contact forces via the pole tube into the remaining structure of the actuating device, the pole tube on its other opposite end preferably has a fixing part which especially positively engages the receiving space between the pole core and the coil element and in this way forms a hooking possibility to prevent the pole tube from being unintentionally pulled out of this receiver between the pole core and coil element in the event of sudden contact of the magnet armature with the other end of the pole tube.

Based on this configuration as claimed in the invention there no longer need be sealing between the pole tube and the flange edge facing toward the interior.

The possibility furthermore exists, by way of the indicated flange edge in addition to the stop surface, of equalizing possible tolerances between the actuation force which arises via the given positioning travel of the magnet armature within a given equalization framework. If specifically the thin-walled flange edge is adjusted in the axial direction with a suitable actuating tool, the possible axial distance between the magnet armature and stop surface changes; this can be used for tolerance equalization, for example for the purpose that within a given working region the applied actuating force remains constant essentially over the feed path (working stroke) of the magnet armature or assumes a defined force characteristic. Regardless of the possible production tolerances of the components of the actuating device, this tolerance can thus be compensated and equalized over the flange edge. Preferably provision is made such that the flange edge of the pole tube facing toward the interior undergoes transition via a feed radius into the cylindrical part of the pole tube and due to the feed radius within the given framework the indicated tolerance equalization can be effected by the corresponding axial length change AX in the direction of the travel of the magnet armature.

Other advantageous embodiments of the actuating device as claimed in the invention are the subject matter of the other dependent claims.

The actuating device as claimed in the invention will be detailed below using one embodiment as shown in the drawings. The figures are schematic and not to scale.

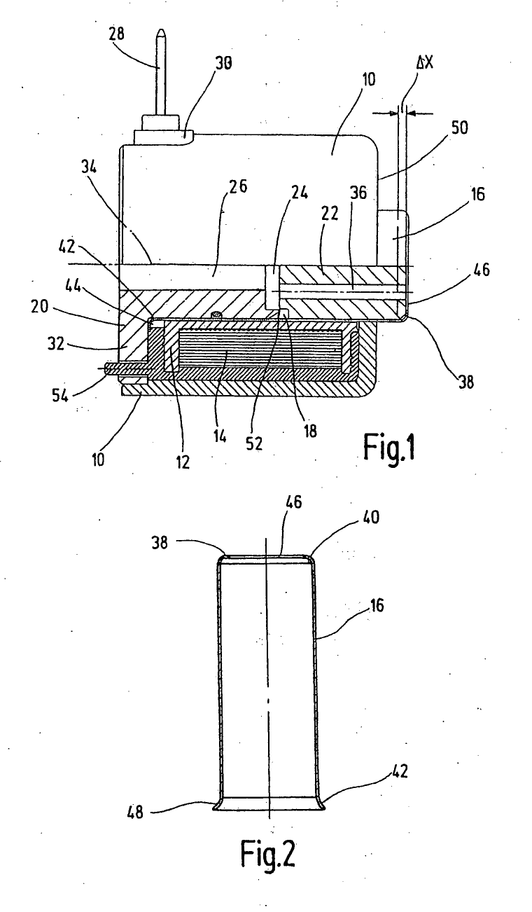

FIG. 1 shows the essential parts of the actuating device partially in a longitudinal section, partially in an elevational view;

FIG. 2 shows enlarged the pole tube used in FIG. 1 as a receiving sleeve for the magnet armature.

The actuating device illustrated in FIG. 1 in the bottom part of the figure in a longitudinal section, which is also to some extent termed an actuating magnet in technical jargon, has a housing 10 on the coil element 12 located therein with a coil winding 14. This coil element 12 comprises at least in part a pole tube 16 which is essentially magnetically decoupled from the pole core 20 by means of a point of separation 18, either in the form of a weld or in the form of a relieved site, as shown in this case. Along the pole tube 16 a magnet armature 22 is guided in a so-called armature chamber 24 which on its free front end interacts with a rod-shaped actuating part (not shown) for purposes of actuating the fluid valves of a design conventional for this purpose, which valves are not detailed. The indicated rod-shaped actuating part which is not detailed is guided to be longitudinally displaceable in a corresponding rod space 26 in the pole core 20. This structure is conventional in these actuating devices, so that it will no longer be detailed here. To deliver current to the coil winding 14 of the coil element 12 there is a plug part 28 which is permanently connected preferably via a potting mass 30 to the housing 10. On its one free end the pole core 20 on the outer peripheral side has a step 32 which widens in diameter in the form of a pole plate. For example the facing end of the coil element 12 can be supported on this step 32 of the pole core 20.

If the coil winding 14 and accordingly the coil are energized via the plug connecting part 28, the magnetic armature 22 is moved into its actuated position, viewed in the direction of looking at FIG. 1, from a right-hand stop position shown there into a left-hand position which corresponds to the actuating position. In this traveling motion the magnetic armature 22 entrains the rod-shaped actuating part which is not detailed, with a free end for the actuation process on the fluid valve which is not detailed which emerges at least partially from the left side of the housing 10. The magnet armature 22 in its axial travel direction along the longitudinal axis 34 of the actuating device is provided with at least one fluid compensation channel 38 which makes it possible to move the fluid located in the armature or chamber space 24 back and forth within the armature chamber 24, depending on the travel position of the magnet armature 22 in order to avoid obstacles in operation. For the resetting motion of the magnet armature 22 from its left-hand position to the right into the position shown in FIG. 1, the coil winding 14 of the coil element 12 can no longer be energized and the resetting motion takes place forcibly via a reset spring which is not detailed and which as part of the fluid valve via its valve plunger sets back the rod-shaped actuating part and consequently the magnet armature 22.

Even when the current is removed however, due to residual magnetism processes on the pole core 20, the possibility exists that the magnet armature 22 with its one free front side remains adhering to the adjacent front side of the pole core 20 which is facing it. To prevent this, it is prior art to place an anti-adhesion means in the form of an anti-adhesion disk, which is not detailed, within the armature chamber 24 between the two front sides, and which encompasses on the one hand the rod-like actuating part, which is not shown, with a radial distance and on the other hand ends in the armature chamber 24 with a small axial distance. The structure and operation of these anti-adhesion disks are described in detail for example in DE 103 27 209 so that they no longer need be detailed here.

As is to be seen in particular in FIG. 2, the pole tube 16 is made in the form of a receiving sleeve for the cylindrical magnet armature 22, the receiving sleeve with the formation of a stop surface 38 for the magnet armature 22 on its free end having a flange edge 40 facing toward the interior and on its other free end engaging a shoulder-like recess 44 in the coil element 12 with a fixing part 42 between the pole core 20 and the coil element 12. The shoulder-like recess 44 ends on its one free end in an annular recess in the coil element 12 and tapers conically with formation of the shoulder-like recess 44 in the direction of the cylindrical part of the pole tube 16. Furthermore the pole tube 16 is sealed on the inner peripheral side via a gasket which is located more or less in the middle on the outer periphery of the pole core 20 in a receiving groove.

The flange edge 40 of the pole tube 16 facing toward the interior leaves a round opening 46 into which with its one end the indicated fluid equalization channel 36 of the magnet armature 22 discharges. As FIG. 2 furthermore shows, the fixing part 42 of the pole tube 16 is formed from a flange edge 48 which faces toward the exterior and which is formed from an obliquely running radial widening of the lower end of the pole tube 16, viewed in the direction of looking at FIG. 2. The upper, inwardly facing flange edge 40 is conversely bordered opposite the other cylindrical outer peripheral surface 40 of the pole tube 16 by 90° to the interior, for example by a flanging process. The inwardly facing flange edge 40 with the interior stop surface 38 forms opposite the free cross sectional surface of the opening 46 only a thin contact ring which the facing free end of the magnet armature 22 can strike via a projecting ring edge (not shown). If this pole tube as shown in FIG. 2 is in its fixed position as shown in FIG. 1, it is ensured that in the resetting motion of the magnet armature 22 into its right stop position shown in FIG. 1, the pole tube 16 cannot be unintentionally pulled out of the receiver between the pole core 20 and the coil body 12. This impedes the fixing part 42 of the pole tube 16 which engages the indicated shoulder-like recess 44 in an inhibitory manner. Compression forces which may occur in the other direction on the pole tube 16 are thus likewise cushioned via the fixing part 42 which runs conically to the exterior.

As is furthermore to be seen in FIG. 1, the pole tube 16 with its inwardly facing flange edge 40 is configured to project a definable distance above the assigned front end 50 of the housing 10. In this connection the defined amount of projection is greater than the free travel of the magnet armature 22 in the armature chamber 24. Based on this projection the actuating device can still be recalibrated accordingly from the exterior in order to equalize the tolerance; this will be detailed below. To form the point of separation 18, it is provided that the pole core 20 on its end side facing the magnet armature 22 is equipped with an annular crosspiece surface 52 which is integrally connected to the cylindrical outer periphery of the pole core 20 over a segment surface which widens conically to the exterior. Furthermore, the diameter of the crosspiece surface 52 is dimensioned such that a front shoulder of the magnet armature 22 engages the part of the armature chamber 24 bordered by way of the crosspiece surface 52 and is guided in it.

As is furthermore to be seen in particular in FIG. 2, the inwardly facing flange edge 40 of the pole tube 16 is configured over a definable feed radius to undergo transition into the cylindrical part of the pole tube 17 so that the working range of the actuating device is adjusted for purposes of calibration or tolerance equalization, especially for the actuating forces, over the positioning travel of the magnet armature 22. Over the indicated feed radius essentially parallel to the longitudinal axis 34 of the actuating device, the flange edge can be turned strengthened to the interior or can be further fixed in the outer region so that as shown in FIG. 1 a ΔX results, a path within which the flange edge 40 can be adjusted in terms of its axial longitudinal alignment. In this way however the free travel path for the magnet armature 22 then changes.

If for example when the actuating device is started up on site, it should be possible to ascertain that a decrease of force is occurring before the magnet armature has traversed it entire feed path (working stroke), ΔX and therefore the free travel can be reduced by further crimping of the flange edge 40 and therefore of the stop surface 38, with the result that after this adjustment process the total actuation force would be available at the end of the travel for the magnet armature 22. In exactly this way, conversely an elongated actuation distance for the magnet armatures 22 via the ΔX setting can be achieved if at any instant of the travel motion of the magnet armature 22 a rather large actuating force is available, with the consequence that longer operating distances on the actuation part for the valve would arise for valve actuation. In any case it is ensured in this way that on site and before start up of the actuating device, but: optionally also later in maintenance operation, tolerance equalization over the ΔX distance can be effected by means of the pole tube 16. The illustrated actuating device is designed especially for the low pressure range; by appropriate spray coating of the housing 10 which is not shown by means of a plastic mass and also as a potting mass, however, the tightness of the actuating device can likewise be increased as well as further support can be achieved, especially in the region of the projection for the pole tube 16, if this projection is encompassed by the respective plastic material.

Furthermore, as shown in FIG. 1, it is provided that a plastic potting mass is routed to the exterior between the coil element 12 and the pole core 20 and the inner peripheral side of the housing 10 in the form of a pin 54 in order in this way to achieve a defined connection possibility which can be checked for the purpose of plausibility control on a pin recess in the fluid valve which is not detailed.

1. Actuating device, especially for actuation of valves which can be connected externally, having a housing (10) and a coil element (12) located therein with a coil winding (14), which encompasses at least in part one pole tube (16) with a pole core (20) connected to its one free end, with a magnet armature (22) which is guided at least in the pole tube (16) within the armature chamber (24) and which interacts with the actuating part for actuating the respective valve, characterized in that the pole tube (16) is made in the form of a receiving sleeve for the magnet armature (22), the sleeve with the formation of a stop surface (38) for the magnet armature (22) on its free end having a flange edge (40) facing toward the interior.

2. The actuating device as claimed in claim 1, wherein the pole tube (16) on its other free end engages with a fixing part (42) between the pole core (20) and the coil element (12).

3. The actuating device as claimed in claim 1, wherein the flange edge (40) of the pole tube (16) facing toward the interior leaves an opening (46) into which with its one end at least one fluid equalization channel (36) discharges, its other respective end discharges into the armature chamber (24)

4. The actuating device as claimed in claim 1, wherein the fixing part (42) of the pole tube (16) is formed from a flange edge (48) which faces toward the exterior and which engages a shoulder-like recess (44) in the coil element (12).

5. The actuating device as claimed in claim 1, wherein the pole tube (16) with its inwardly facing flange edge (40) over a definable path projects above the assigned front end (50) of the housing (10).

6. The actuating device as claimed in claim 5, wherein the definable amount of projection is greater than the free travel of the magnet armature (22) in the armature chamber (24).

7. The actuating device as claimed in claim 1, wherein the pole core (20) on its end side facing the magnet armature (22) is equipped with an annular crosspiece surface (52) which is integrally connected to the cylindrical outer periphery of the pole core (20) over a segment surface which widens conically to the exterior.

8. The actuating device as claimed in claim 7, wherein the diameter of the crosspiece surface (52) is dimensioned such that a front shoulder of the magnet armature (22) engaging the part of the armature chamber (24) bordered by way of the crosspiece surface (52) is guided in it.

9. The actuating device as claimed in claim 1, wherein the flange edge (40) of the pole tube (16) facing toward the interior passes via a feed radius into the cylindrical part of the pole tube (16).

10. The actuating device as claimed in claim 1, wherein the free end of the pole tube (16) projecting to the exterior over the housing (10) can be spray-coated with a plastic material.
